(19) United States
(12) Patent Application Publication
(10) Pub. No.: US 2008/0245416 A1
(43) Pub. Date: Oct. 9, 2008

(54) Device and Method for Distribution of Two Mutually Immiscible Liquids

(75) Inventors: Ralf Meier, Dortmund (DE); Joerg Leistner, Haltern am See (DE)

Correspondence Address: OBLON, SPIVAK, MCCLELLAND MAIER & NEUSTADT, P.C., 1940 DUKE STREET, ALEXANDRIA, VA, 22314, US

(73) Assignee: EVONIK DEGUSSA GmbH, Essen (DE)

(21) Appl. No.: 12/067,323

(22) PCT Filed: Sep. 19, 2006
(86) PCT No.: PCT/EP2006/066497

§ 371 Date: Mar. 19, 2008

(30) Foreign Application Priority Data
Sep. 23, 2005 (DE) 10 2005 045 745.2

(51) Int. Cl. G05D 11/02; B01D 53/18; B01F 13/10

(52) U.S. Cl. 137/9; 137/89; 137/109; 137/561 A; 137/2

(57) ABSTRACT

The invention relates to a device and a method for distributing two liquids that cannot be mixed with each other for mass transfer and heat exchange columns, comprising at least one distributor channel or a distributor channel arrangement, the distributor channel being fed one or more liquids in different phases via at least one inflow from a collecting device arranged above said distributor channel, and said distributor channel having overflow and/or outflow openings for the distribution of the liquids. The device according to the invention is distinguished by the fact that the distributor channel has at least one internal means for the phase separation of the liquid and that separate outflow and/or overflow openings are provided for each of the phases to be separated, the cross section and/or elevation of which openings are arranged in dependence on the physical properties of the liquids in such a way that a homogeneous distribution of the liquids on the basis of predetermined phase components is achieved.

The invention relates to a device for distributing two liquids that cannot be mixed with each other for mass transfer and heat exchange columns, comprising at least one distributor channel or a distributor channel arrangement, the distributor channel being fed one or more liquids in different phases via at least one inflow from a collecting device preferably arranged above said distributor channel, and said distributor channel having overflow and/or outflow openings for the distribution of the liquids.

The invention also relates to a method for distributing two liquids that cannot be mixed with each other on a packing of solid material or on structured internals of a column.

The distribution of liquids on packings of solid material or structured internals is an important task in many chemical engineering processes. Apart from the distribution of the liquids in fixed-bed reactors (tubular reactors, trickle-bed reactors . . . ), liquid distributions are used in separating columns (tray columns or packed columns). In particular, the separating result in packed columns (dump or structured packing internals) for the thermal material separation of mixtures is decisively determined by a homogeneous liquid distribution. Devices of the type mentioned at the beginning are usually used for this purpose. Such devices usually comprise distributor channels, from which the liquid can flow away through openings distributed over the entire cross section. The openings may be arranged on the underside, on the side plates of the distributor channels or on the sides of outflow tubes provided in the distributor channels. Homogeneous flowing-away characteristics are achieved by influencing the outflow rate of the liquid, on the one hand by means of setting the size and number of outflow openings and on the other hand by means of choosing the submergence level of the liquid. The outflow rate of the liquid is proportional to the root of the head of the liquid. In order to achieve adequate distribution quality of the liquid in the case of very large surface areas to be trickled, multistage distributor constructions are known. These are essentially suitable for the homogeneous distribution of a liquid phase or a liquid with certain physical properties. If the distribution of a number of liquids or liquids in different phases is to be performed, often a temporally or locally inadequate distribution quality is obtained. In separating columns for example, such unequal liquid distribution (maldistribution) brings about a reduction in the separation efficiency.

A device of the type mentioned at the beginning is known for example from U.S. Pat. No. 6,189,566 B1. It describes a liquid distributor for packing columns that is intended to be particularly suitable for distributing a liquid medium comprising a mixture of different materials that tends to develop inhomogeneities, for example as a result of segregation or polymerization. Special internals are intended to have the effect that the two phases of the liquid that cannot be mixed with each other are intensively mixed within the distributor arrangement. For this purpose, it is proposed to use in the distributor channels internals in the form of deflecting plates which are provided with relatively small opening passages. This causes a narrowing of the flow cross section in the region of the internals and an acceleration of the flow, which is intended to ensure intensive mixing of the phases. These internals represent flow resistances, which correspondingly use up flow energy, which has to be taken into account in the design of the submergence level of the distributor channels. For this purpose, it is necessary to increase the overall height of the entire distributor channel arrangement or the entire distributor construction correspondingly. In addition, the mixing of the liquids is not stable. Partial segregation of the liquids occurs in the region of flow dead zones, with the end effect that a homogeneous distribution of the liquids is not ensured with the construction described in U.S. Pat. No. 6,189,566.

The invention is therefore based on the object of improving a device and a method of the type stated at the beginning.

The device according to the invention is distinguished by the fact that the distributor channel or the distributor channel arrangement has at least one internal means for the phase separation of the liquids and that separate outflow and/or overflow openings are provided for each of the phases to be separated, the cross section and/or elevation of which openings are arranged or chosen in dependence on the physical properties of the liquids in such a way that a homogeneous distribution of the liquids on the basis of predetermined phase ratios is achieved.

The invention is based on the realization that a homogenization of two phases that cannot be mixed with each other is generally unstable, so that a temporary segregation can scarcely be prevented, in particular in flow dead zones, with the overall result that it appears to be more favourable to bring out the phases from the distributor arrangement separately, to be precise in such a way that uniform and homogeneous flowing-away on the basis of predetermined phase ratios can be accomplished.

To achieve the aforementioned object, therefore a method for distributing two liquids that cannot be mixed with each other on a packing of solid material or on a structured column by means of at least one distributor channel or a distributor channel arrangement is also provided, the distributor channel being fed the liquids via at least one common inflow from a collecting device preferably arranged above in the installed position, and the different phases initially being inhomogeneously distributed. The method is distinguished by the fact that a phase separation is performed within the distributor channel or within the distributor channel arrangement and that the individual phases are separately removed.

In the case of the device according to the invention, it is expedient to provide as internals at least one channel separation extending in the direction of flow, which subdivides the distributor channel into at least two flow paths connected to one another on the principle of communicating tubes, each flow path being assigned outflow and/or overflow openings. The longitudinal division of the flow paths has the effect of minimizing flow resistances. The different flow paths are connected to one another in the manner of communicating tubes, so that a phase separation on the basis of the differing density of the liquid can be established. This is assisted by conducting the flow within the distributor channel in such a way that it is as laminar as possible. The segregated liquids can then be removed separately via the outflow and/or overflow openings assigned to each flow path. The magnitude of the phase components to be brought out can be set by means of the size, geometry and overall height of the overflow openings. The outflow and/or overflow openings are preferably dimensioned and arranged in such a way that the phase ratios to be brought out are approximately equal.

In the case of a preferred variant of the device according to the invention, it is provided that the distributor channel is provided with two channel divisions, which form an inner flow path and outer flow paths communicating with one another.

The distributor channel is preferably formed as a channel which is open at the top in the installed position and is divided in the longitudinal direction into at least two flow paths, at least one intermediate wall being provided as the channel division, which wall is not connected to the bottom of the channel, or only partially, on its side facing the bottom of the channel, thereby leaving an overflow gap, or is provided at its end facing the bottom of the channel with overflow apertures.

The flow division is achieved by means of such a channel division, the function being the converse of a weir in the conventional sense, with the overflow taking place below the liquid level.

In the case of one variant of the device according to the invention, it is provided that the inner flow path communicates via first overflow openings of a first predetermined elevation with outlets arranged approximately centrally with respect to the longitudinal extent of the distributor channel, preferably in the form of tubes, whereas the outer flow paths are provided with second, outer overflow openings, which are arranged at a second predetermined elevation. The first and second elevations may also be equal.

It is expedient if the two overflow openings are respectively provided on both outer sides of the distributor channel.

In the case of one variant of the device according to the invention, it is provided that aprons are respectively provided on the outer sides of the distributor channel, respectively forming with the outer sides of the distributor channel outlet gaps for the liquid leaving the second overflow openings.

The invention is explained below on the basis of an exemplary embodiment represented in the drawings, in which:

FIG. 1) shows a schematic view of a distributor channel according to a first exemplary embodiment of the invention in cross section,

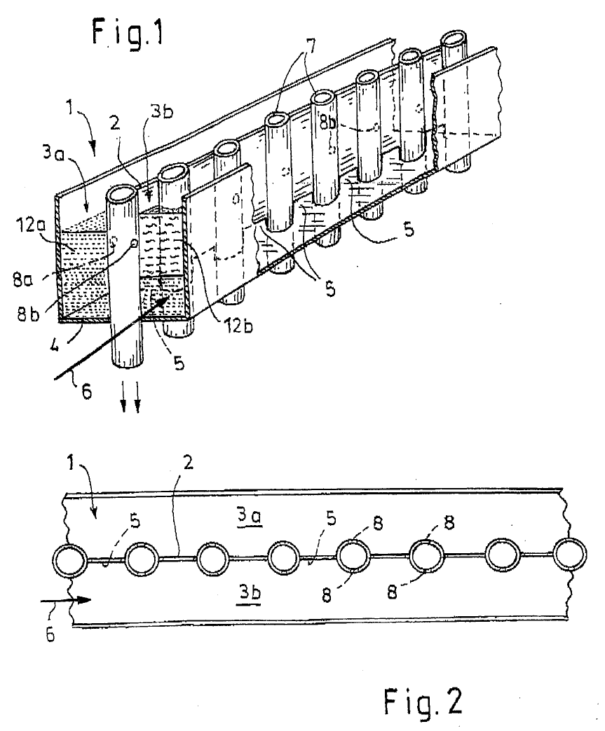

FIG. 2) shows a plan view of the distributor channel represented in FIG. 1,

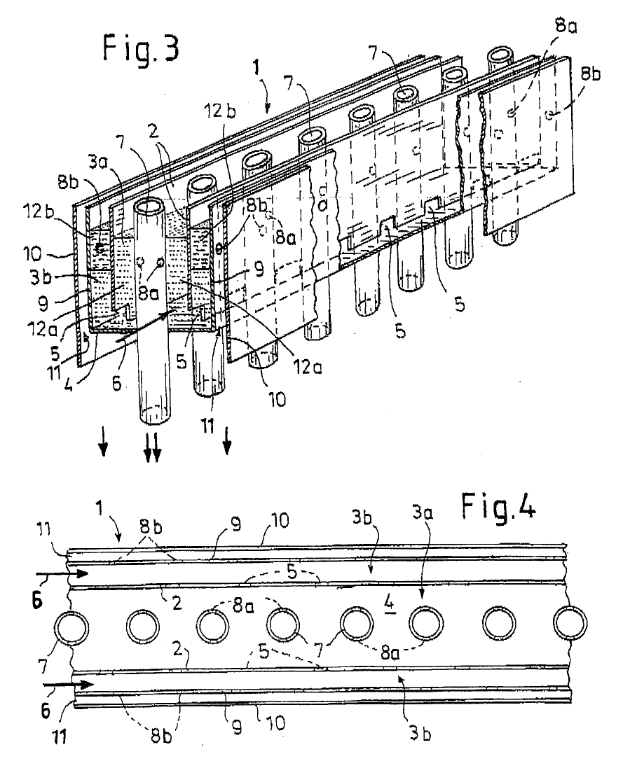

FIG. 3) shows a cross section through an alternative configuration of the distributor channel according to the invention and

FIG. 4) shows a plan view of the distributor channel represented in FIG. 3.

For the sake of simplicity, only the distributor channel and its functional principle are illustrated in the drawing.

The inflow of liquids via a collecting device and the precise path followed by the distributor channel are not represented in the drawings. The invention is to be understood as being such that the liquid distributor device comprises an arrangement of distributor channels which are formed in a way corresponding to the distributor channel represented, the channels as far as possible covering the entire cross section of a packing column, for example. These details are known to a person skilled in the art and therefore do not require any further explanation.

The device according to the exemplary embodiment described below comprises in the simplest case (FIG. 1) a distributor channel designated by 1, which is formed as a channel which extends into the plane of the drawing and is approximately U-shaped in cross section. The distributor channel 1 is subdivided by means of a weir-like intermediate wall 2 into a first flow path 3a and a second flow path 3b. The intermediate wall 2 extends at a distance from the bottom 4 of the distributor channel 1, so that an overflow 5 is formed between the flow paths 3a, 3b. Instead of a continuous overflow gap, isolated apertures, arranged at a distance from one another, may also be provided in the intermediate wall 2 in the region of the bottom 4 of the distributor channel 1.

By means of an inflow that is designated by 6 and is only schematically represented in the form of arrows, the flow path 3b is supplied with two liquids in different phases with inhomogeneous distribution. The inflow 6 can take place by means of an in-front, transversely running inflow channel arranged above, or in some other suitable way. Since the flow paths 3a, 3b are connected to one another on the principle of communicating tubes, a different phase distribution will be respectively established in the two flow paths 3a and 3b, as indicated in FIG. 1, on account of the differing density of the two phases of the liquid mixture. The liquid of greater density, liquid 12a, passes through the overflow gap 5 of the intermediate wall 2 and builds up on the side of the intermediate wall 2 that is facing away from the inflow 6 in the flow path 3a, over a residue of the liquid 12a of greater density. The liquid of lower density, liquid 12b, remains in the flow path 3b. Outflow tubes are designated by 7, are arranged approximately centrally with respect to the longitudinal extent of the distributor channel 1 at a distance from one another and are connected to the flow paths 3a, 3b by overflow openings 8a,b that are only indicated. The liquid of greater density is designated by 12a, the liquid of lower density is designated by 12b.

In the case of the exemplary embodiment represented in FIG. 1, the flow paths 3a, 3b may for example be respectively connected to different outflow tubes 7, it being possible for the overflow openings to be arranged at different heights, according to the physical properties of the liquids to be distributed and according to the predetermined phase ratios with which they are to be distributed. In the case of the exemplary embodiment represented, the first flow path 3a is connected via first overflow openings to the overflow tube 7, the second flow path 3b is connected via second overflow openings 8b at approximately the same height on the opposite side to the same overflow tube.

In the exemplary embodiment of the distributor channel 1 represented in FIG. 3, two intermediate walls 2 are provided, subdividing the distributor channel 1 into an inner flow path 3a and two outer flow paths 3b. The outer flow paths 3b are respectively provided with two overflow openings 8b in the outer wall 9 of the distributor channel. The inner flow path 3a is connected via first overflow openings 8a to the outflow tubes 7. In the case of the variant of the distributor channel 1 represented in FIG. 3, the liquid 12a of greater density collects in the inner flow path 3a. This liquid enters the outflow tubes 7 via the overflow openings 8a; the liquid 12b of lower density remains in the outer flow paths 3b and leaves via the overflow openings 8b.

To make the distribution of the liquid leaving at the outer walls 9 of the distributor channel 1 still more uniform, respectively provided on the outside of the distributor channel 1 are aprons 10 in the form of plates or the like, which respectively form with the outer wall 9 of the distributor channel 1 an outlet gap 11 for the liquid.

### LIST OF REFERENCE NUMERALS

1 distributor channel

2 intermediate walls

3a,b flow paths

4 bottom

5 overflow gap

6 inflow

7 outflow tubes

8,8a,8b overflow openings

9 outer walls of the distributor channel

10 aprons

11 outlet gap

12a,b liquid

1. A device for distributing two liquids that cannot be mixed with each other for mass transfer and heat exchange columns, comprising at least one distributor channel or a distributor channel arrangement, the distributor channel being fed one or more liquids in different phases via at least one inflow from a collecting device, and said distributor channel having overflow and/or outflow openings for the distribution of the liquids, wherein the distributor channel or the distributor channel arrangement has at least one internal means for the phase separation of the liquids and the separate outflow and/or overflow openings are provided for each of the phases to be separated, the cross section and/or elevation of which openings are arranged in dependence on physical properties of the liquids, wherein a homogeneous distribution of the liquids on the basis of predetermined phase components is achieved.

2. The device according to claim 1, wherein, as an internal means, at least one channel division extends in the direction of flow, which subdivides the distributor channel into at least two flow paths connected to one another on the principle of communicating tubes, each flow path being assigned outflow and/or overflow openings.

3. The device according to claim 1, wherein the distributor channel is provided with two channel divisions, which form an inner flow path and outer flow paths communicating with one another.

4. The device according to claim 1, wherein the distributor channel is formed as a channel which is open at the top in an installed position and is divided in the longitudinal direction into at least two flow paths, at least one intermediate wall being provided as the channel division, which wall is not connected or partially connected to the bottom of the channel on its side facing the bottom of the channel, thereby leaving an overflow gap, or is provided at its end facing the bottom of the channel with overflow apertures.

5. The device according to claim 3, wherein the inner flow path communicates via first overflow openings of a first predetermined elevation with outlets arranged approximately centrally with respect to the longitudinal extent of the distributor channel.

6. The device according to claim 3, wherein the outer flow paths are provided with second outer overflow openings, which are arranged at a second predetermined elevation.

7. The device according to claim 6, wherein the second overflow openings are respectively provided on both outer sides of the distributor channel.

8. The device according to claim 6, wherein aprons are respectively provided on the outer sides of the distributor channel, respectively forming with the outer sides of the distributor channel outlet gaps for the liquid leaving the second overflow openings.

9. A method for distributing two liquids that cannot be mixed with each other on a packing of solid material or on structured internals of a column by means of at least one distributor channel or a distributor channel arrangement which is fed the liquids via at least one common inflow from a collecting device arranged above in the installed position, the different phases initially being inhomogeneously distributed, wherein a phase separation is performed within the distributor channel or within the distributor channel arrangement and individual phases are separately removed.

10. The method according to claim 9, wherein the distribution is performed on the basis of predetermined phase components in dependence on the physical properties of the liquids.
